(19) United States
(12) Patent Application Publication
(10) Pub. No.: US 2006/0190240 A1
(43) Pub. Date: Aug. 24, 2006

(54) Method and system for locating language expressions using context information

(76) Inventors: Han-Jin Shin, Dong-gu (KR); Han-Woo Shin, Dong-gu (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/405,212

(22) Filed: Apr. 17, 2006

Related U.S. Application Data
(63) Continuation of application No. PCT/KR04/02632, filed on Oct. 14, 2004.

(30) Foreign Application Priority Data
Oct. 15, 2003 (KR) 10-2003-0071966

(51) Int. Cl. G06F 17/20

(52) U.S. Cl. 704/1

(57) ABSTRACT

Disclosed is corpus-retrieval language education system having a question/answer function. The system includes an information provider unit for dividing dialogue data and sentence data into text data, audio data and video data, storing each divided data as corpus data in a language data storing section, extracting language data corresponding to question text data inputted by a user from the language data storing section and outputting the extracted data in predetermined order of education through a network, and a subscriber unit for sending question text data to the information provider unit through the network and outputting the language data received from the information provider unit through a Web browser or a speaker. When the user inputs question text data requesting dialogues or sentences in a foreign language which are useful to communicate with native speakers, the information provider unit promptly extracts the required language data (including text data, audio data and vide data) as an answer to the user's question data. The language data can be stored in a separate storage device so that the user can form a language learning resource that will best fit his or her needs and ability.

### CROSS-REFERENCE TO RELATED PATENT APPLICATIONS

This application is a continuing application under 35 U.S.C. § 365(c) of International Application No. PCT/KR2004/002632, filed Oct. 14, 2004 designating the United States. International Application No. PCT/KR2004/002632 was published in English as WO2005/038683 A1 on Apr. 28, 2005.

This application further claims for the benefit of the earlier filing dates under 35 U.S.C. § 365(b) of Korean Patent Application No. 10-2003-0071966 filed Oct. 15, 2003. This application incorporates herein by reference the International Application No. PCT/KR2004/002632 including WO2005/038683 A1 and the Korean Patent Application No. 10-2003-0071966 in their entirety.

### BACKGROUND OF THE INVENTION

1. Technical Field

The present invention relates to a method and system for locating language expressions, and, more particularly, to a method and system for locating and providing language expressions in reply to a user's request.

2. Description of Related Technology

With the rapid development of wireless Internet technologies, various contents and approaches to realtime language learning have become available through the Internet or wireless networks.

Most Internet educations of language, however, are unilaterally offered by the education service providers to the learners, which is not likely to be effective in learning a language. Also, most textbooks with uniform or similar contents do not satisfy instantaneous demands of learners. Both Internet language educations and textbooks are still highly limited to meet the needs of learners who wish to acquire instantaneous language data in real communicative situations.

Although various methods for effectively learning a foreign language (for example, memorizing whole sentences, speaking at different speeds and loudly shouting with precise pronunciations) have been suggested, none of the methods appears to instantly solve verbal foreign language acquisition problems. Learners may also feel it difficult to sustain the requisite motivation needed to dedicate themselves. What learners really need is to instantly solve problems in real communicative situations and to acquire optimum language data as required by the individual learners. Conventional approaches to language learning or education are not successful in view of such needs and demands and even fail to motivate the learners to study and learn a foreign language.

### SUMMARY OF CERTAIN INVENTIVE ASPECTS

One aspect of the invention provides a method for processing an inquiry for language expressions, which may comprise: providing a database comprising a plurality of entries of language expression data, each entry comprising a language expression and information indicative of at least one of a location and an action associated with the language expression; receiving an inquiry from a user comprising either or both of location information and action information; and locating from the database one or more entries comprising information that matches or relates to either or both of the location information and the action information of the inquiry. The method may further comprise sending one or more language expressions of the located entries to the user or a device to display or play an audio of the one or more language expressions.

In the foregoing method, either or both of the location information and the action information may be in a first language, and the language expression may be in a second language different from the first language. The one or more language expressions may comprise a conversational language expression. The one ore more language expressions may be in at least one form of selected from the group consisting of text data, audio data and video data. The inquiry may be received via the Internet.

Another aspect of the invention provides a method for requesting for and obtaining language expressions, which may comprise: establishing a connection with a server; sending to the server an inquiry for language expressions, the inquiry comprising either or both of location information and action information; and receiving from the server or a device associated with the server one or more language expressions associated with either or both of the location information and an action information and stored at the server. The one or more expressions may be those stored at the server or the associated device along with information that matches or relates to either or both of the location information and the action information of the inquiry.

The method may further comprise playing an audio of the one or more expressions. The method may further comprise displaying texts of the one or more language expressions or displaying a motion or still image associated with the one or more language expressions. The method may be carried out using one or more devices selected from the group consisting of a desktop computer, a notebook computer, a hand-held computer, a PDA and a mobile phone.

In the foregoing method, sending the inquiry may comprise inputting both the location information and the action information one after the other. Sending the inquiry may comprise inputting either or both of the location information and the action information in text or audio data. Either or both of the location information and the action information may be in a first language, and the one or more language expressions may be in a second language different from the first language. The one or more language expressions and either or both of the location information and the action information may be in the same language.

Still another aspect of the invention provides a system for providing language expressions in reply to an inquiry, which may comprise: a database comprising a plurality of entries of language expression data, each entry comprising a language expression and information indicative of at least one of a location and an action associated with the language expression; an input module configured to receive an inquiry from a user requesting for at least one language expression, the inquiry comprising either or both of location information and action information; and a processor configured to locate one or more entries comprising information that matches or relates to either or both of the location information and the action information of the inquiry. The system may further comprise an output module configured to send to the user one or more language expressions located by the processor.

In the foregoing system, the language expression may comprise a conversational language expression. Either or both of the location information and the action information may be in a first language, and wherein the language expression may be in a second language different from the first language. The language expression may be in at least one form selected from the group consisting of texts data, audio data and video data.

Still another aspect of the present invention provides a system and method for providing the most proper answer to a question inputted by a user based on corpus data concerning dialogues for diverse situations and sentences.

Still another aspect of the present invention provides a system and method for separately managing language data selected according to a user's personal learning environments, such as occupation, ability to learn, place and purpose of language learning and providing various language learning tools and approaches for personalized language learning in the personal learning environments.

Still another aspect of the present invention provides a system and method for searching a language materials database and corpus data to extract a proper answer to a question inputted by a user and recording the extracted answer in a wire-line or wireless Internet network terminal (such as a PC, a mobile phone or a PDA) and a conventional recording medium (such as a CD, a tape or a book).

Further another aspect of the present invention provides a language education system having a subscriber unit and an information provider unit capable of receiving and transmitting data for language learning through a wire-line or wireless network terminal, which comprises: a language data storing section for storing language data including text data and audio/video data about dialogues for diverse situations and sentences helpful to communicate with native speakers; a detector for analyzing request data inputted from the subscriber unit through a network and extracting language data corresponding to the request data; a transmission control section for controlling transmission of the language data extracted by the detector to the subscriber unit through the network; and a language data control section for receiving the language data through the network and controlling the output of the received language data for learning with various language learning methods and multimedia tools.

In accordance with another aspect of the present invention, the language education system further comprises a member data storing section for storing membership information received from the subscriber unit through the network and providing identification information necessary to transmit the extracted language data to the subscriber unit to the transmission control section.

In accordance with still another aspect of the present invention, the language education system further comprises: a dialogue data buffer and a sentence data buffer for respectively storing dialogue data and sentence data extracted from the language data storing section; an AV data buffer for storing audio/video data corresponding to the dialogue data and the sentence data; and a received text buffer and a received audio buffer for respectively storing text data and audio data inputted by a user of the subscriber unit.

In accordance with still another aspect of the present invention, the detector of the information provider unit consists of a first comparator and a second comparator for classifying the request data inputted from the subscriber unit based on its place or location value, function or action value and/or natural language according to a search type selected by the user from a dialogue search and a sentence search and extracting language data corresponding to the request data from the language data storing section.

In accordance with still another aspect of the present invention, the transmission control section of the information provider unit divides the extracted language data into text data, audio data and video data and transmitting the divided data to the subscriber unit.

In accordance with still another aspect of the present invention, the language data control section of the subscriber unit includes: a text data buffer and an audio data buffer for dividing the language data received from the information provider unit through the network into text data and audio data and storing the text data and the audio data, respectively; a search menu select section for selecting a dialogue data search or a sentence data search; and a learning process control section for controlling a series of operations for language learning, including storing the language data in the buffers and implementing a language program.

Still further another aspect of the present invention provides a corpus-retrieval language education system having a question/answer function, which comprises: an information provider unit for dividing dialogue data and sentence data into text data, audio data and video data, storing each divided data as corpus data in a language data storing section, extracting language data corresponding to question text data inputted by a user from the language data storing section and outputting the extracted data in predetermined order of education through a network; and a subscriber unit for sending question text data to the information provider unit through the network and outputting the language data received from the information provider unit through a Web browser or a speaker. The subscriber unit is any of a PC, a PDA and a mobile phone.

Still further another aspect of the present invention provides a language education method using a corpus-retrieval language education system having a question/answer function, which comprises the steps of: sending question text data inputted by a user on a subscriber unit to an information provider unit; extracting dialogue data or sentence data corresponding to the question text data received through a network; transmitting the extracted dialogue data or sentence data to the subscriber unit through the network; and outputting the received dialogue data or sentence data through a Web browser or a speaker of the subscriber unit according to a language program. The language education method further comprises the step of providing a search type select menu to enable the learner to select a dialogue data search or a sentence data search.

In addition, said step of extracting dialogue data corresponding to the question text data extracts dialogue data that conforms to a place value or location information and a function value or action information of the question text data received from the subscriber unit. When only a place value is present in the question text data, the information provider unit requests a re-input of the question text data including a function value or extracts dialogue data that conforms to the place value only. When only a function value is present in the question text data, the information provider unit requests a re-input of the question text data including a place value or extracts dialogue data that conforms to the function value only.

### BRIEF DESCRIPTION OF THE DRAWINGS

The above and other features and advantages of the present invention will be more apparent from the following detailed description taken in conjunction with the accompanying drawings, in which:

FIG. 1 is a view showing the constructions of an information provider unit and a subscriber unit of a corpus-retrieval language education system having a question/answer function according to an embodiment of the present invention;

FIG. 2 is a view showing the constructions of an information provider unit and a subscriber unit for personalized language learning according to another embodiment of the present invention;

FIGS. 3a to 3g are views showing the structures of the language materials database and membership database in FIGS. 1 and 2;

FIG. 4 is a flow chart showing the operation of a corpus-retrieval language education system having a question/answer function according to the present invention;

FIG. 5 is a flow chart showing a personalized language learning method according to the present invention;

FIGS. 6a to 6c are flow charts showing the operations of the detector in FIG. 1; and

FIG. 7 is a flow chart showing a personalized language learning process using the system in FIG. 2.

### DETAILED DESCRIPTION OF EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

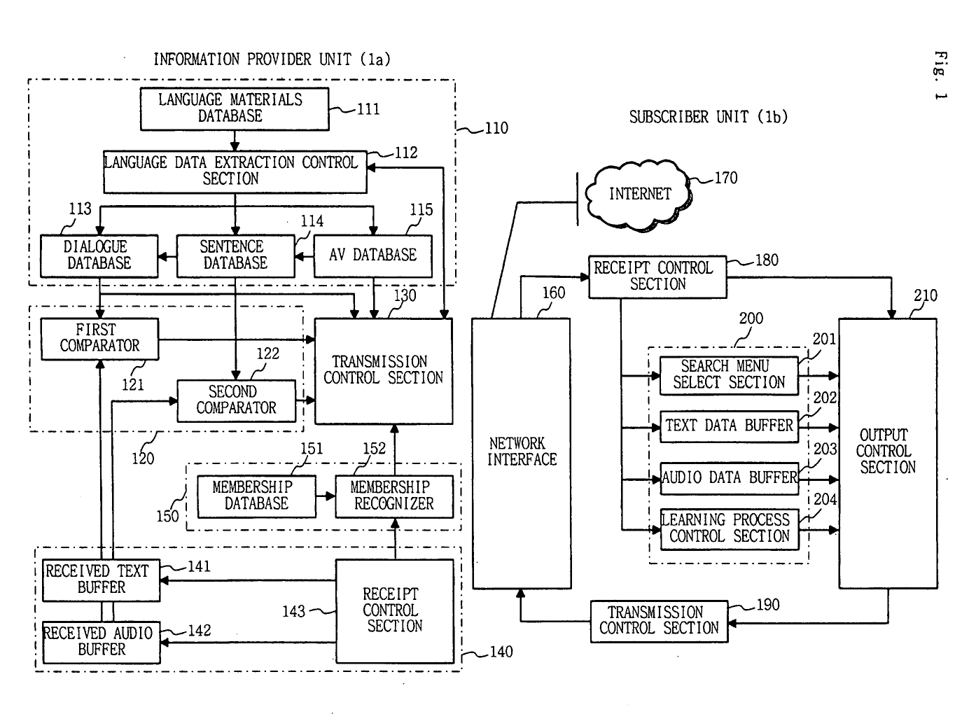

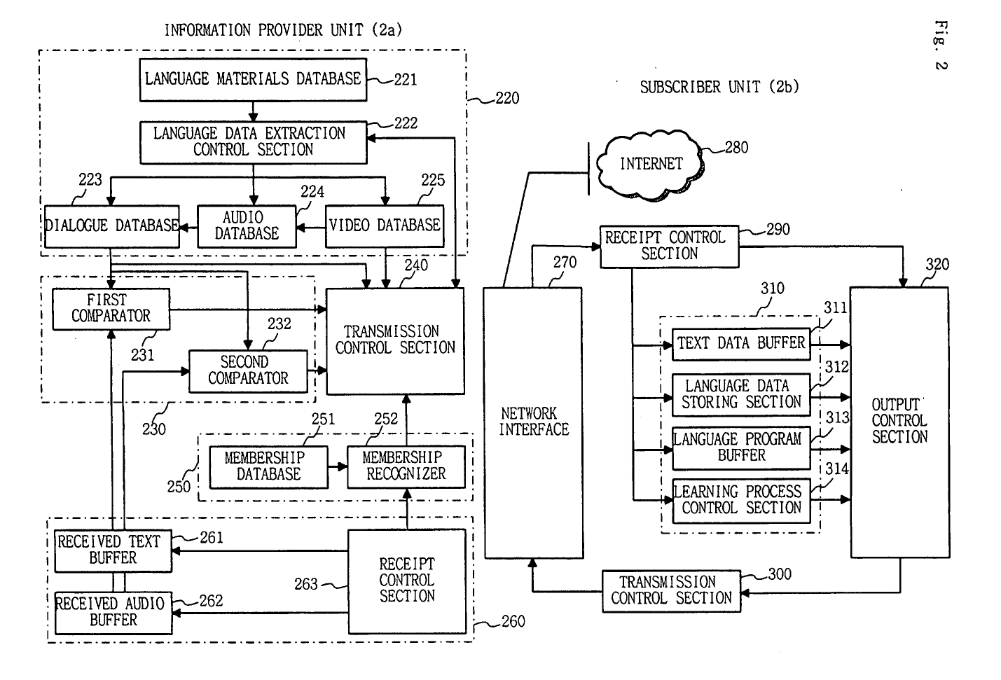

FIGS. 1 and 2 show a language education system capable of providing an answer to a user's question inputted through a subscriber unit by corpus retrieval.

FIG. 1 shows the construction of a language education system using a corpus retrieval technique. Regarding an information provider unit included in the language education system, FIG. 1 provides drawing reference numeral 110 for a language data storing section, 111 for a language materials database, 112 for a language data extraction control section, 113 for a dialogue data buffer, 114 for a sentence data buffer, 115 for an AV data buffer, 120 for a detector, 121 for a first comparator, 122 for a second comparator, 130 for a transmission control section, 143 for a receipt control section, 141 for a received text buffer, 142 for a received audio buffer, 150 for a membership management section, 151 for a membership database and 152 for a membership recognizer.

Referring to FIG. 1, when a user selects either a dialogue data search or a sentence data search through a search type select section 201 provided in a subscriber unit 1b and inputs question text data in a search window, the inputted text data is transferred to the transmission control section 190 via an output control section 210. The text data is then transferred to the receipt control section 143 of the information provider unit I a via a network interface 160.

The text data transferred to the receipt control section 143 is stored in the received text buffer 141 (when the user inputs audio data, the inputted audio data is stored in the received audio buffer 142) and inputted again to the first comparator 121 and the second comparator 122. The first comparator 121 compares the inputted text data with dialogue data stored in the dialogue data buffer 113. When any of the stored dialogue data is detected to correspond to the inputted text data, the first comparator 121 transfers the detected dialogue data to the transmission control section 130. The second comparator 122 compares the inputted text data with sentence data stored in the sentence data buffer 114. When any of the stored sentence data is detected to correspond to the inputted text data, the second comparator 122 transfers the detected sentence data to the transmission control section 130.

Hereinafter, the language data storing section 110 included in the information provider unit 1a will be explained in more detail. All language data is stored in the language materials database 111 of the language data storing section 110. The language materials database 111 may comprise a DB server. The language data stored in the language materials database 111 is extracted under the control of the language data extraction control section 112 and stored in the buffers according to their contents. In other words, dialogue data, sentence data and audio/vide data extracted from the language materials database 111 are stored respectively in the dialogue data buffer 113, sentence data buffer 114 and AV data buffer 115.

The dialogue data buffer 113 stores corpus data collections of dialogues for diverse situations. For example, the dialogue data buffer 113 may store a corpus of dialogues possible when cooking at home, such as when hungry and while preparing foodstuff and cooking. In this context, for example, the place or location information may refer to terms such as home, kitchen, restaurant. For example, the function or action information may refer to terms such as eating, cooking, dining out, ordering food.

The question text data inputted from the subscriber unit 1b is inputted to the received text buffer 141 (or the received audio buffer 142 when the question text data inputted from the subscriber unit 1b is audio data). The text data or audio data is compared with dialogue data or sentence data by the first comparator 121 or second comparator 122 of the detector 120. According to the results of comparison, desired language data is finally extracted under the control of the language data extraction control section 112. At this time, language data accumulated by the number of n is extracted.

Dialogue data and sentence data that will be provided to the subscriber unit 1b are called together with audio and video data in the AV data buffer 115 and extracted by the language data extraction control section 112 according to a control signal generated from the transmission control section 130. The extracted dialogue data and sentence data, including audio/video data, are inputted to the transmission control section 130 and transmitted to the subscriber unit 1b through the network interface 160. By contrast, the data inputted from the subscriber unit 1b through the network interface 160 is transferred to the receipt control section 143 of the information provider unit 1a. When the inputted data is text, it is transferred to the received text buffer 141. When the inputted is audio data, it is transferred to the received audio buffer 142.

The detector 120 consists of the first comparator 121 and the second comparator 122. The first comparator 121 compares the inputted text data with dialogue data stored in the dialogue data buffer 113. When any of the stored dialogue data is detected to correspond to the inputted text data, the first comparator 121 transfers the detected dialogue data as language data to the transmission control section 130. The second comparator 122 compares the inputted text data with sentence data stored in the sentence data buffer 114. When any of the stored sentence data is detected to correspond to the inputted text data, the second comparator 122 transfers the detected sentence data as language data to the transmission control section 130.

The language data (dialogue data or sentence data) transferred to the transmission control section is inputted to the receipt control section 180 of the subscriber unit 1b through the network interface 160. Text included in the language data inputted to the receipt control section 180 is outputted to the Web browser of the subscriber unit 1b, while audio data included in the language data is outputted to the speaker of the subscriber unit 1b under the control of the output control section 210. Based on identification information inputted from the membership recognizer 152, the transmission control section 130 determines to which subscriber unit 1b the language data extracted from the information provider unit 1a should be outputted. Upon receiving identification information of a subscriber unit 1a inputted through the receipt control section 143, the membership recognizer 152 identifies the subscriber unit 1a based on the membership information stored in the membership database 151 and sends the identification information of the subscriber unit 1a to the transmission control section 130.

The data transmission between the information provider unit 1a and the subscriber unit 1b through the Internet has been explained. Preferably, the subscriber unit 1b should be any of a PC, a mobile phone or a PDA.

It is also possible to store language data provided from the information provider unit I a in both a wireless network terminal (for example, a mobile phone or a PDA) and a mobile storage device (for example, a tape, a CD, a DVD, a semiconductor chip or a language player) to provide the language data in the lump to the subscriber unit. Then the user can download the language data in the lump to his or her own wireless network terminal to use the data in language learning. Accordingly, the language education system of the present invention is applicable to both on-line and off-line language education or learning.

FIG. 2 shows the constructions of an information provider unit and a subscriber unit for personalized language learning according to the present invention. Language data corresponding to question text data inputted by the user is extracted from a language materials database 221 of an information provider unit 2a and stored in a language data storing buffer 312 of a subscriber unit 2b. The language data stored in the language data storing buffer 312 is outputted through the Web browser or speaker of the subscriber unit 2a for the user's personalized language learning, with the implementation of a language program stored in a language program buffer 313 under the control of a learning process control section 314. Regarding the information provider unit 2a, FIG. 2 provides drawing reference numeral 220 for a language data storing section, 230 for a detector, 240 for a transmission control section, 250 for a membership management section and 260 for a receipt control section. Regarding the subscriber unit 2b, FIG. 2 provides drawing reference numeral 290 for a receipt control section, 300 for a transmission control section and 320 for an output control section.

All language data is stored in the language materials database 221 of the language data storing section 220. The language materials database 221 may comprise a DB server. A language data extraction control section 222 extracts required language data from the language materials database 221. The extracted language data is stored in a dialogue data buffer 223 according to their contents. At this time, audio data and video data included in the language data extracted from the language materials database 221 are stored respectively in an audio data buffer 224 and a video data buffer 225.

When the user inputs question text data, a first comparator 231 compares the question text data (a place or location value and a function action value in the question text data) with dialogue data stored in the dialogue data buffer 223. When any of the stored dialogue data is detected to correspond to the question text data, the first comparator 231 transfers the detected dialogue data to the transmission control section 240. The second comparator 232 compares the inputted question text data with stored sentence data. When any of the stored sentence data is detected to correspond to the question text data, the second comparator 232 transfers the detected sentence data to the transmission control section 240. At this time, the dialogue data and the sentence data are transferred to the transmission control section 240, together with audio data and video data extracted respectively from the audio data buffer 224 and the video data buffer 240.

The language data transferred to the transmission control section 240 of the information provider unit 2a is inputted to the receipt control section 290 of the subscriber unit 2b through a network interface 270. The language data inputted to the receipt control section 290 is outputted through the Web browser and speaker of the subscriber unit 2b, with the implementation of the program stored in the language program buffer 313 under the control of the learning process control section 314.

Among the provided language data, the user can select only those necessary for his or her own personalized language learning and store the selected data in a separate storing section (not shown). The data stored in the storing section is not dialogue data or sentence data, but an identification code matching for the dialogue data or the sentence data.

For personalized language learning, the user has to access data stored in the storing data. In this regard, the identification code stored in the storing section is sent to the information provider unit 2a through the transmission control section 300 and the network interface 270.

More specifically, the identification code corresponding to the language data for the user's own personalized language learning is inputted to the information provider unit 2a and compared with the dialogue data by the first comparator 231. When the first comparator 231 detects dialogue data corresponding to the identification code, it transfers the detected data to the transmission control section 240. At this time, the detected dialogue data is transferred to the transmission control section 240, together with audio data and video data extracted respectively from the audio data buffer 224 and the video data buffer 225.

The language data for personalized language learning transferred to the transmission control section 240 is sent to the subscriber unit 2b through the network interface 270. The subscriber unit 2b outputs the received language data through the Web browser and speaker, with the implementation of the language program stored in the language program buffer 313 under the control of the learning process control section 314.

The language education system explained above enables transmission of language data between the information provider unit 2a and the subscriber unit 2b through the Internet for personalized language learning of the user. Preferably, the subscriber unit 2b should be any of a PC, a mobile phone or a PDA.

It is also possible to store language data provided from the information provider unit 1 a in both a wireless network terminal (for example, a mobile phone or a PDA) and a mobile storage device (for example, a tape, a CD, a DVD, a semiconductor chip or a language player) to provide the language data in the lump to the subscriber unit. Then the user can download the language data in the lump to his or her own wireless network terminal to use the data in language learning. Accordingly, the language education system of the present invention is applicable to both on-line and off-line language education or learning.

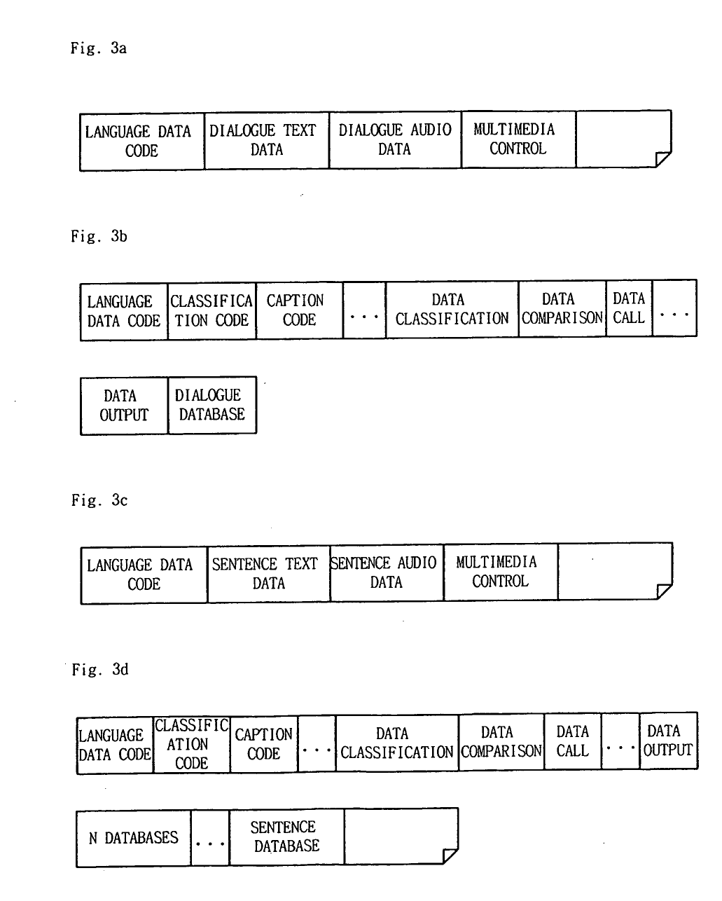

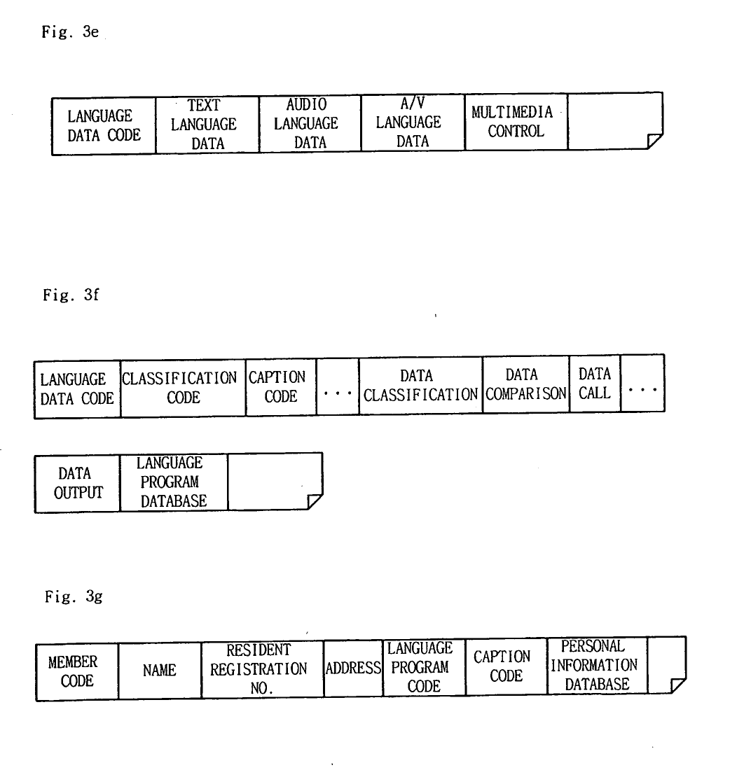

FIGS. 3a to 3g shows the structures of the language materials database 111 or 221 and the membership database 151 or 251 in FIG. 1 or 2.

Specifically, information files of a multimedia dialogue database, a dialogue-level language materials database, a multimedia sentence database, a sentence-level language materials database, a multimedia database for personalized language learning, a language materials database for personalized language learning and a membership database are depicted in FIGS. 3a, 3b, 3c, 3d, 3e and 3f, respectively.

As shown in FIG. 3a, the multimedia dialogue database consists of the fields of a language data code, dialogue text data, dialogue audio data and multimedia control data. As shown in FIG. 3b, the dialogue-level language materials or language expressions database consists of the fields of a language data code, classification code, caption code, data classification, data comparison, data call, data output and dialogue database. The dialogue data is classified according to place or location information and function values or action information and formed as corpus data. As shown in FIG. 3c, the multimedia sentence database consists of the fields of a language data code, sentence text data, sentence audio data and multimedia control data. As shown in FIG. 3d, the sentence-level language materials or language expressions database consists of the fields of a language data code, classification code, caption code, data classification, data comparison, data call, data output, N databases and sentence database. Sentence data provided and outputted to the subscriber unit can be one sentence or a set of n sentences that matches text data inputted by the user. As shown in FIG. 3e, the multimedia database for personalized language learning consists of the fields of a language data code, text language data, audio language data, video language data and multimedia control data. As shown in FIG. 3f, the language materials database for personalized language learning consists of the fields of a language data code, classification code, caption code, data classification, data comparison, data call, data output and language program database. The language program data includes programs for curriculum, lecture instruction, test and self-assessment. As shown in FIG. 3g, the membership database consists of the fields of a member code, name, resident registration number, address, language program code, caption code and personal information database. The caption code field records the last date of study.

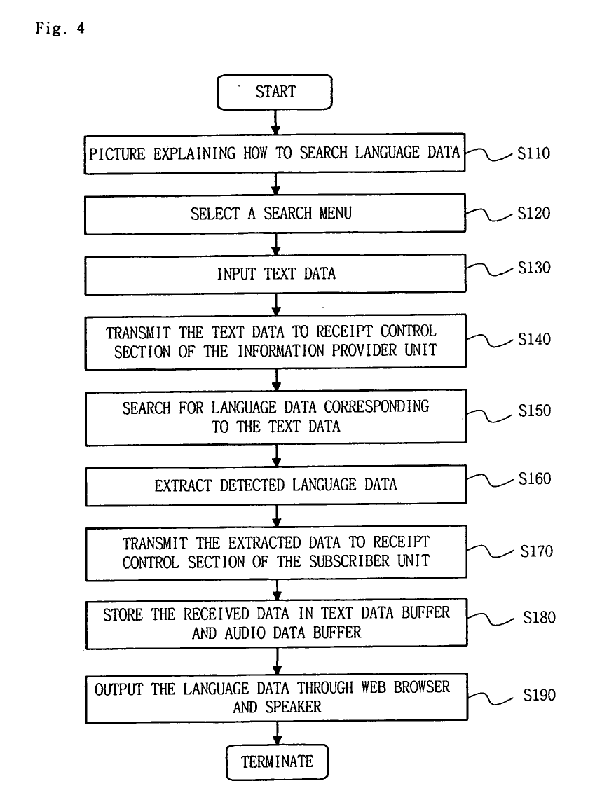

Hereinafter, a language education method using a language education system having answer/question and corpus retrieval functions according to the present invention will be explained in detail with reference to FIG. 4.

The output control section 210 of the subscriber unit 1b displays a picture explaining how to search language data (S110). The picture consists of audio data, video data and text data. The user can skip or stop the picture.

Subsequently, the user has to select a search menu for extracting dialogue data or sentence data (S120). After selecting a search menu, the user has to input text data in a search window (S130).

The text data inputted by the user is transferred to the transmission control section 190 through the output control section 210. The transmission control section 190 then inputs the received text data to the receipt control section 143 of the information provider unit 1a through the network interface 160 (S140).

The text data inputted to the receipt control section 143 is stored in the received text buffer 141 and then inputted again to the first comparator 121 and the second comparator 122 which will search for language data corresponding to the values or information of the inputted text data (S150). More specifically, the text data is inputted to the first comparator 121 if the user has selected the dialogue data search at step 120, or to the second comparator 122 if the user has selected the sentence data search.

If any corresponding language data is detected, the language data extraction control section 112 will extract the detected language data (S160). At this time, the extracted language data may include dialogue or sentence text data and audio data. The extracted language data is transferred to the receipt control section 180 of the subscriber unit 1b through the network interface 160 (S170). Text included in the language data transferred to the receipt control section 180 is stored in the text data buffer 202, while audio data included in the language data is stored in the audio data buffer 203 (S180)

The stored language data is outputted through the Web browser or the speaker of the subscriber unit 1b under the control of the learning process control section 204 so that the user can read or hear the outputted data. Whether the language data is outputted through the Web browser or the speaker is determined according to the user's selection of language learning mode (e.g., a reading mode or a hearing mode). Of course, the user can select both the reading mode and the hearing mode to read and hear the language data simultaneously. When selecting a speaking mode, the user can speak the language and practice dialogues (language learning through dialogues).

Language learning in the reading, hearing or speaking mode is possible with the operation of a language program under the control of the learning process control section 204 of the subscriber unit 1b.

As explained above, when the user inputs text data using the subscriber unit 1b, the text data is transferred to the information provider unit 1a. The information provider unit 1a extracts dialogue or sentence data corresponding to the inputted text data from the language materials database 111 and transmits the extracted data to the subscriber unit 1b. The user can study the received language data in various language learning modes such as reading, hearing and speaking modes, thereby maximizing the language learning efficiency.

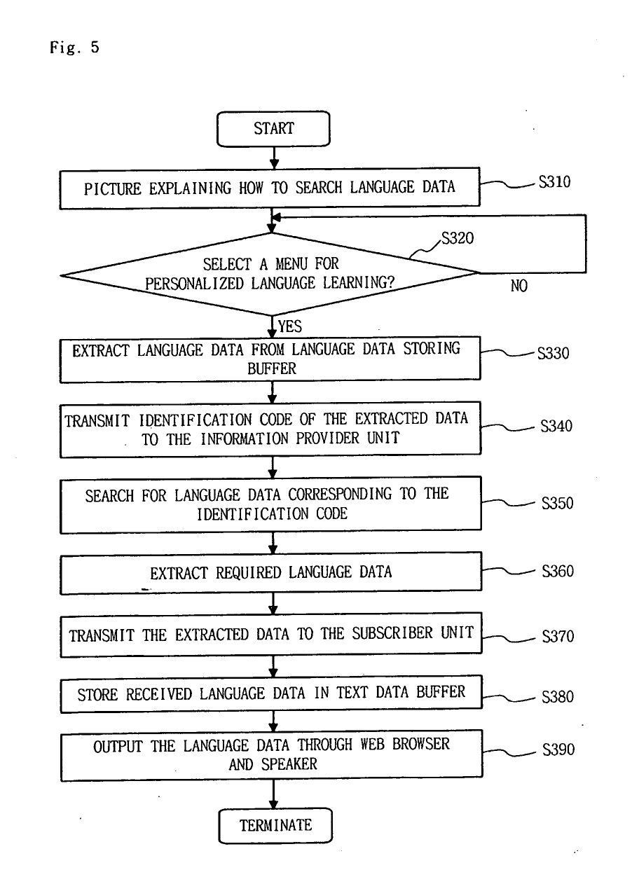

FIG. 5 is a flow chart showing a language education method that enables a personalized language learning according to the present invention.

The output control section 210 of the subscriber unit 2b in FIG. 2 displays a picture explaining how to search language data (S310). The data consists of audio data, video data and text data. The user can skip or stop the picture.

When the user selects a menu for personalized language learning using language data stored in the language data storing buffer 312 (S320), the language program is operated under the control of the learning process control section 314 to extract language data stored in the language data storing buffer 312 (S330). The extracted language data is transmitted to the information provider unit 2a (S340). At this time, the extracted language data is an identification code matching for dialogue or sentence data. In other words, the language data stored in the language data storing buffer 312 is not dialogue or sentence data, but merely a set of identification codes matching for the dialogue or sentence data. Upon receiving an identification code, the information provider unit 2a extracts corresponding dialogue or sentence data and sends the extracted data to the subscriber unit 2b.

The language data to be transmitted to the information provider unit 2a (i.e., the identification code stored in the language data storing buffer 312 for dialogue or sentence data) is first transferred to the transmission control section 300 through the output control section 320 and then inputted to the receipt control section 263 of the information provider unit 2a via the network interface 270.

The identification code inputted to the receipt control section 263 is stored in the received text buffer 261. The identification code is inputted to the first comparator 231 when it corresponds to dialogue data or to the second comparator 232 when it corresponds to sentence data. The first comparator 231 or the second comparator 232 detects language data identical to the identification code (S350).

When any language data identical to the identification code is detected, the language data extraction control section 222 extracts the detected language data from the language materials database 221 (S360). The extracted language data includes text data and audio data of dialogues or sentences. The extracted language data is transmitted to the receipt control section 290 of the subscriber unit 2b (S370). Also, the language data is stored in the text data buffer 311 (S380).

The stored language data is outputted through the Web browser or the speaker of the subscriber unit 2b so that the user can study the language data in various language learning modes such as lecture, speech and test modes (S390)

It is possible to change information inputted for personalized language learning in a personal information mode according to the user's learning environments and ability. The multimedia function is also adjustable. The target language data is stored in the language data storing buffer 312 in FIG. 2. At this time, the language data stored in the language data storing buffer 312 is not actual dialogue or sentence data, but an identification code matching for the dialogue or sentence data.

The user can use the language program to form a language learning resource that will best fit his or her needs and abilities. The user can improve his or her language skills by personalized language learning.

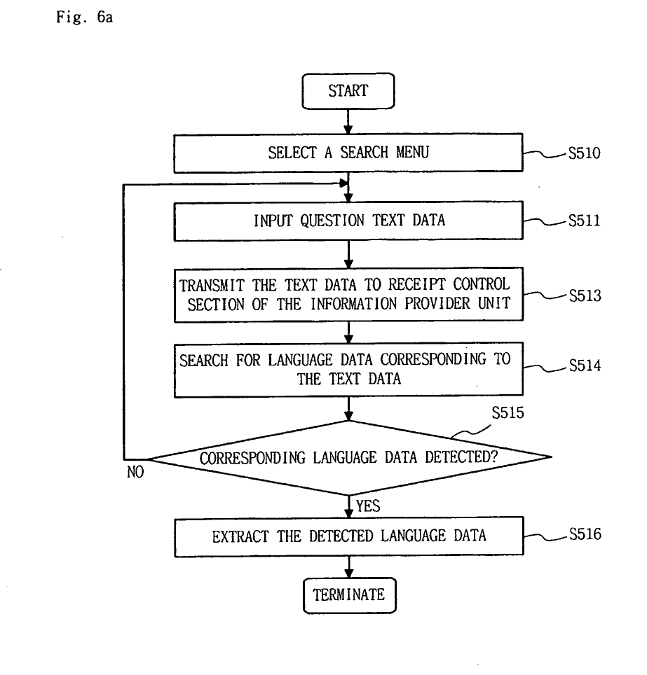

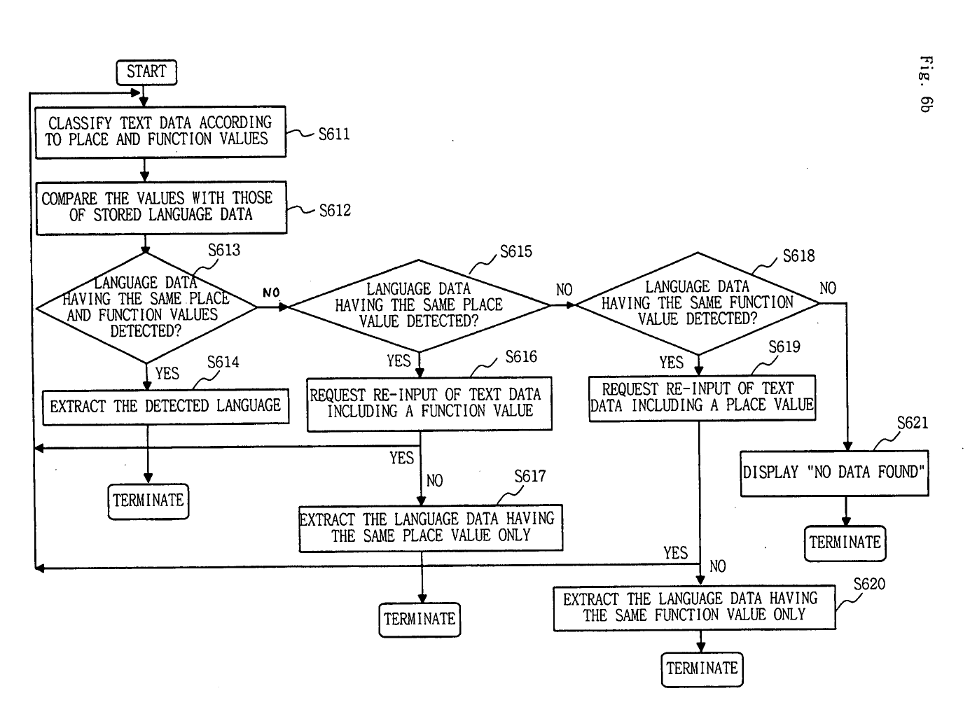

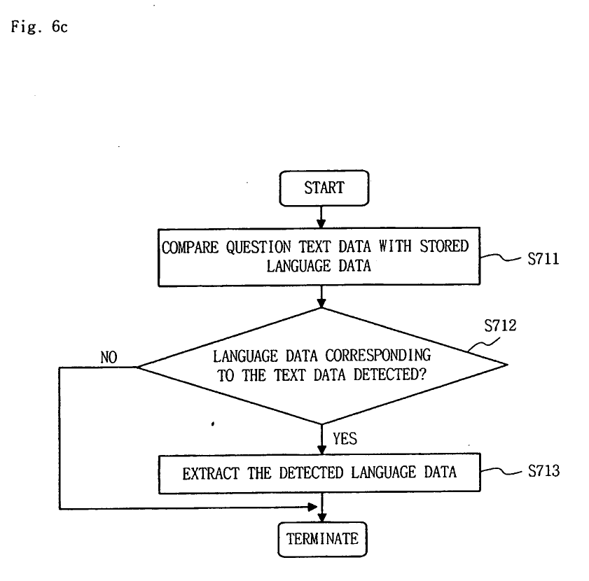

FIG. 6a is a flow chart showing the operations of the detector 120 in FIG. 1 to compare text data inputted by the user and detect corresponding language data.

When the user selects a search menu (S511), an initial picture for a dialogue data search or a sentence data search is outputted through the Web browser. The user can then input text data (S512). The inputted text data is transmitted to the receipt control section 143 of the information provider unit 1 a through the network interface 160 (S513).

According to the search type selected by the user, the detector 120 of the information provider unit 1a controls the first comparator 121 or the second comparator 122 to search for language data corresponding to the values or information of the inputted text data (S514). For example, if the user has selected the dialogue data search, the first comparator 121 will search for dialogue data corresponding to the inputted text data. When any corresponding dialogue data is detected (S515), it will be extracted (S516) and transmitted to the subscriber unit 1b so that the user can study the dialogue data in a selected language learning mode such as speaking or hearing mode. The user can repeat or stop the language data search and learning process upon his or her selection. If no dialogue or sentence data corresponding to the inputted text data is detected by the detector 120, the subscriber unit 1b will return to the initial text data input mode.

FIG. 6b is a flow chart showing a more detailed process of searching for dialogue data. FIG. 6c is a flow chart showing a process of searching for sentence data. These processes will be explained with reference to the language education system in FIG. 1.

Referring to FIG. 6b, the detector 120 classifies the text data inputted to the received text buffer 141 according to its place or location information and function or action information (S611) and compares the information or values of the text data with stored language data (S612). To be specific, the place information or value and function information or value of the inputted text data are compared with those of the language data stored in the language materials database 111. If the detector 120 detects language data having the same place or location information and function or action information (S613), it will extract the language data or language expression (S614).

If language data identical only in the place or location value is detected, the detector 120 will request a re-input of text data including a function or action value (S616). The user may input the function or action information or re-input text data including both the place and function values in response to the request or reject the re-input request. When the re-input request is rejected, the detector 120 will extract the language data identical only in the place or location value (S617).

On the other hand, if language data identical only in the function or action value is detected, (S618), the detector 120 will request a re-input of text data including a place or location value (S619). The user may input the place or location information or re-input text data including both the place and function values in response to the request or reject the re-input request. When the re-input request is rejected, the detector 120 will extract the language data identical only in the function action value (S620).

If no language data having the same place or location information or function or action information is detected, the subscriber unit 1b will display “no data found” (S621).

The language data extracted at step 614, 617 or 620 is outputted through the Web browser or speaker of the subscriber unit 1b so that the user can study the language data.

Referring to FIG. 6c, the detector 120 of the information provider unit 1a compares text data inputted by the user with language data stored in the language materials database 111 (S711).

The detector 120 searches the language materials database 111 to detect language data corresponding to the values of the inputted text data (S712). When any corresponding language data is detected, the detector 120 will extract the detected language data (S713). At this time, language data can be extracted by the number of n in the order of matching rates for the inputted text data.

The n language data is transmitted to the subscriber unit 1b via the transmission control section 130.

If no corresponding language data is detected at step 712, the detector 120 will inform the user that no data was found, and if necessary; will request a separate data storage device (not shown) to provide the desired language data to the subscriber unit 1a.

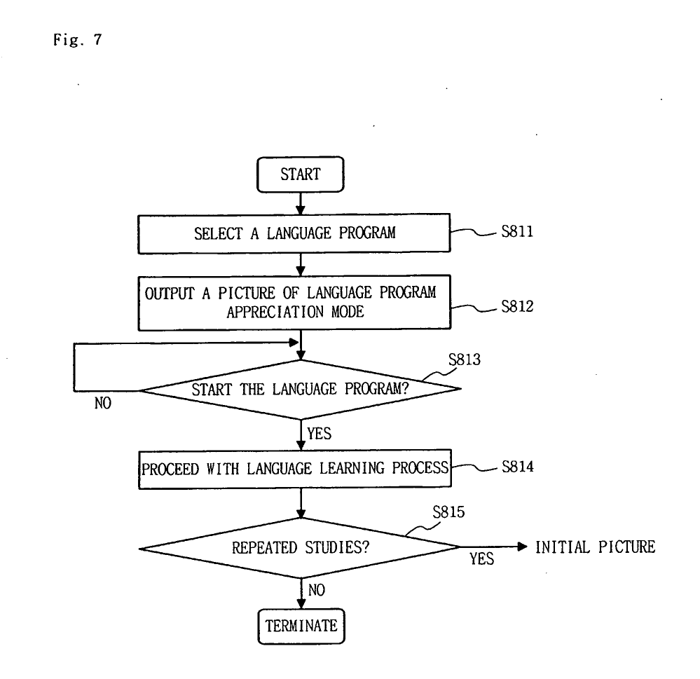

FIG. 7 is a flow chart showing a personalized language learning process. When the user selects a desired language program (S811), the subscriber unit 1b calls the language program and outputs a picture of a language program appreciation mode (S812). The user can skip or continue the picture.

The subscriber unit 1b determines whether the user selects the start of the language learning process (S813). If so, the language program will be operated to enable the user to proceed with the desired language learning process (S814). During the process, the user can record or store specific language data in the language data storing data 312 in order to call and use the stored data when needed at a later time. The user can more effectively learn the language using multimedia tools (for example, GVA lecture, video lecture, messenger service, mobile phone and PDA).

When the user selects repeated studies (S815), the subscriber unit 1b displays the initial picture for selecting a language program.

The language learning process explained above is carried out by transmitting data through the Internet and using language data stored in the language data storing buffer 312 in FIG. 2. The user and a third person can simultaneously access language data in the information provider unit to study the data in realtime. It is also possible to transmit all language data selected by the user to the user's own terminal (subscriber unit) so that the user can extract and study required data.

In addition, the language materials database 221 of the information provider unit 2a can be stored in both a wireless network terminal (for example, a mobile phone or a PDA) and a mobile storage device (for example, a tape, a CD, a DVD, a semiconductor chip or a language player) to provide language data in the lump to the subscriber unit. Then the user can download the language data in the lump to his or her own wireless network terminal to use the data in language learning. Accordingly, the language education system responding to the user's query by corpus retrieval and the personalized language learning method according to the present invention are applicable to both on-line and off-line language education or learning.

Conventional language education methods using textbooks with uniform or similar contents do not satisfy the needs and demands of learners who wish to acquire instantaneous language data in real communicative situations. Since most learners repeatedly study and memorize expressions useful in a limited number of situations, they become embarrassed when faced with an unexpected or unfamiliar communicative situation. The present invention can solve these problems in conventional language education or learning methods. The language education system according to the present invention stores dialogues or sentences in a target language useful to communicate with native speakers as corpus data. When a user inputs question text data, language data (including text data, audio data and video data) extracted by corpus retrieval is promptly provided as an answer to the user's question through the Internet. According to the present invention, the language data extracted by corpus retrieval can be stored in a separate storage device so that the user can form a language learning resource that will best fit his or her needs and abilities. The user can more effectively learn the language on-line and off-line using various multimedia tools and language programs.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for processing an inquiry for language expressions, the method comprising:
providing a database comprising a plurality of entries of language expression data, each entry comprising a language expression and information indicative of at least one of a location and an action associated with the language expression;
receiving an inquiry from a user comprising either or both of location information and action information; and
locating from the database one or more entries comprising information that matches or relates to either or both of the location information and the action information of the inquiry.

2. The method of claim 1, further comprising sending one or more language expressions of the located entries to the user or a device to display or play an audio of the one or more language expressions.

3. The method of claim 1, wherein either or both of the location information and the action information is in a first language, and wherein the language expression is in a second language different from the first language.

4. The method of claim 1, wherein the one or more language expressions comprises a conversational language expression.

5. The method of claim 1, wherein the one ore more language expressions are in at least one form of selected from the group consisting of text data, audio data and video data.

6. The method of claim 1, wherein the inquiry is received via the Internet.

7. A method for requesting for and obtaining language expressions, the method comprising:
establishing a connection with a server;
sending to the server an inquiry for language expressions, the inquiry comprising either or both of location information and action information; and
receiving from the server or a device associated with the server one or more language expressions associated with either or both of the location information and an action information and stored at the server.

8. The method of claim 7, wherein the one or more expressions are those stored at the server or the associated device along with information that matches or relates to either or both of the location information and the action information of the inquiry.

9. The method of claim 7, further comprising playing an audio of the one or more expressions.

10. The method of claim 7, further comprising displaying texts of the one or more language expressions or displaying a motion or still image associated with the one or more language expressions.

11. The method of claim 7, wherein the method is carried out using one or more devices selected from the group consisting of a desktop computer, a notebook computer, a hand-held computer, a PDA and a mobile phone.

12. The method of claim 7, wherein sending the inquiry comprises inputting both the location information and the action information one after the other.

13. The method of claim 7, wherein sending the inquiry comprises inputting either or both of the location information and the action information in text or audio data.

14. The method of claim 7, wherein either or both of the location information and the action information is in a first language, and wherein the one or more language expressions are in a second language different from the first language.

15. The method of claim 7, wherein the one or more language expressions and either or both of the location information and the action information are in the same language.

16. A system for providing language expressions in reply to an inquiry, the system comprising:
a database comprising a plurality of entries of language expression data, each entry comprising a language expression and information indicative of at least one of a location and an action associated with the language expression;
an input module configured to receive an inquiry from a user requesting for at least one language expression, the inquiry comprising either or both of location information and action information; and
a processor configured to locate one or more entries comprising information that matches or relates to either or both of the location information and the action information of the inquiry.

17. The system of claim 16, further comprising an output module configured to send to the user one or more language expressions located by the processor.

18. The system of claim 16, wherein the language expression comprises a conversational language expression.

19. The system of claim 16, wherein either or both of the location information and the action information is in a first language, and wherein the language expression is in a second language different from the first language.

20. The system of claim 16, wherein the language expression is in at least one form selected from the group consisting of texts data, audio data and video data.

21. A corpus-retrieval language education system having a question/answer function and comprising a subscriber unit and an information provider unit capable of receiving and transmitting data for language learning through a wire-line or wireless network terminal, which includes:
a language data storing section for storing language data including text data and audio/video data about dialogues for diverse situations and sentences helpful to communicate with native speakers;
a detector for analyzing request data inputted from the subscriber unit through a network and extracting language data corresponding to the request data;
a transmission control section for controlling transmission of the language data extracted by the detector to the subscriber unit through the network; and
a language data control section for receiving the language data through the network and controlling the output of the received language data for learning with various language learning methods and multimedia tools.

22. The corpus-retrieval language education system as claimed in claim 21, further including a member data storing section for storing membership information received from the subscriber unit through the network and providing identification information necessary to transmit the extracted language data to the subscriber unit to the transmission control section.

23. The corpus-retrieval language education system as claimed in claim 21, further including:
a dialogue data buffer and a sentence data buffer for respectively storing dialogue data and sentence data extracted from the language data storing section;
an AV data buffer for storing audio/video data corresponding to the dialogue data and the sentence data; and
a received text buffer and a received audio buffer for respectively storing text data and audio data inputted from the subscriber unit.

24. The corpus-retrieval language education system as claimed in claim 21, wherein said detector of the information provider unit consists of a first comparator and a second comparator for classifying the request data inputted from the subscriber unit based on its place value, function value and/or natural language according to a search type selected by the user from a dialogue search and a sentence search and extracting language data corresponding to the request data from the language data storing section.

25. The corpus-retrieval language education system as claimed in claim 21, wherein said transmission control section of the information provider unit divides the extracted language data into text data, audio data and video data and transmitting the divided data to the subscriber unit.

26. The corpus-retrieval language education system as claimed in claim 21, wherein the language data control section of the subscriber unit includes:
a text data buffer and an audio data buffer for dividing the language data received from the information provider unit through the network into text data and audio data and storing the text data and the audio data, respectively;
a search menu select section for selecting a dialogue data search or a sentence data search; and
a learning process control section for controlling a series of operations for language learning, including storing the language data in the buffers and operating a language program.
